(19) United States
(12) Patent Application Publication
(10) Pub. No.: US 2024/0306606 A1
(43) Pub. Date: Sep. 19, 2024

(54) ELECTRONIC PET WAND

(71) Applicant: The Kyjen Company, LLC, Centennial, CO (US)

(72) Inventors: Danielle Salyer, Denver, CO (US); Jeffrey Paris, Los Angeles, CA (US); Chaz Ozzello, Englewood, CO (US)

(21) Appl. No.: 18/608,608

(22) Filed: Mar. 18, 2024

Related U.S. Application Data
(60) Provisional application No. 63/453,048, filed on Mar. 17, 2023.

(51) Int. Cl. A01K 15/02

(52) U.S. Cl. CPC A01K 15/025

(57) ABSTRACT

An electronic pet wand includes a housing, a wand extending from the housing, and a motor disposed in the housing configured to oscillate the wand. The electronic cat wand may further include a control circuit including a switch movable between a first position and a second position. The control circuit may be configured to cause the motor to oscillate the wand when the switch is in the second position.

### BACKGROUND OF THE DISCLOSURE

This application claims the benefit of priority to U.S. Provisional application entitled “ELECTRONIC CAT WAND” filed Mar. 17, 2023 and assigned Ser. No. 63/453,048, the entire disclosure of which is hereby expressly incorporated by reference.

### FIELD OF THE DISCLOSURE

The present disclosure relates generally to pet toys. More specifically, the present disclosure relates to an interactive electronic cat wand configured to stimulate and entertain pets.

### Brief Description of Related Technology

Generally, a wide variety of pet toys are available to keep pets entertained. For example, pet toys including one or more of a squeaker, a bell, crinkle paper, and the like may be configured to make noise, entertaining pets. Other pet toys include balls, frisbees, wands, toys including treats (e.g., cat nip, pet treats), chew toys, and the like. However, pets may quickly become disinterested in their toys. Accordingly, there is a need for more dynamic and interactive pet toys that engage pets for longer periods of time.

### SUMMARY OF THE DISCLOSURE

In accordance with one aspect of the present disclosure, an electronic pet wand includes a housing, a wand extending from the housing, and a motor disposed in the housing configured to oscillate the wand.

In accordance with another aspect of the present disclosure, an electronic cat wand includes a housing configured to be held by a user, a wand extending from the housing, and a motor disposed in the housing configured to oscillate the wand.

In accordance with yet another aspect of the present disclosure, an electronic cat wand includes a handle, a wand extending from the handle, and a motor disposed in the handle configured to oscillate the wand.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 illustrates a perspective view of a cat wand in accordance with one example of the present disclosure.

FIG. 2 illustrates an exploded view of the cat wand of FIG. 1 in accordance with one example of the present disclosure.

FIG. 3 illustrates a partial perspective view of the cat wand of FIG. 1 in accordance with one example of the present disclosure.

FIG. 4 illustrates a partial perspective view of the cat wand of FIG. 1 in accordance with one example of the present disclosure.

FIG. 5 illustrates a partial exploded view of the housing of the cat wand of FIG. 1 in accordance with one example of the present disclosure.

FIG. 6 illustrates a perspective view of the first panel of the cat wand of FIG. 1 in accordance with one example of the present disclosure.

FIG. 7 illustrates a side view of the housing of the cat wand of FIG. 1 in accordance with one example of the present disclosure.

While the disclosed pet toys and methods are susceptible of embodiments in various forms, there are illustrated in the drawings (and will hereafter be described) specific embodiments of the disclosure, with the understanding that the disclosure is intended to be illustrative and is not intended to limit the disclosure to the specific embodiments described and illustrated herein.

### DETAILED DESCRIPTION OF THE DISCLOSURE

The present disclosure is provided to solve the above-mentioned problems in the Background of the Disclosure section. Specifically, the present disclosure provides an electronic cat wand including a housing, a wand extending from the housing, and a motor configured to move the wand. According to some examples, the housing may be a handle having an ergonomic shape configured to be held by a human user (e.g., pet owner). According to some examples, the disclosed cat wand may include a control circuit including a switch movable between a first position and a second position. The control circuit may be configured to cause the motor to move (e.g., oscillate) the wand based on a position of the switch. Specifically, when the switch is in a first position, the motor may be off and the wand may be stationary, Conversely, when the switch is in the second position, the motor may be on, causing the wand to oscillate. According to some examples, the disclosed cat wand may also include a button, and the control circuit may be configured to stop the motor from oscillating the wand when the button is depressed. According to some examples, in addition to stopping oscillation of the wand, the control circuit may be configured to cause the motor to vibrate or rapidly oscillate the wand back and forth in a sweeping motion when the button is depressed.

Accordingly, an electronic cat wand according to the present disclosure may include multiple functionalities (e.g., wand oscillation, wand vibration) and multiple user input devices advantageously allowing a user (e.g., pet owner) to dynamically interact with the cat wand and thus provide a pet with a dynamic and interactive playing experience.

According to some examples of the present disclosure, the housing may have an ergonomic shape, such that a user may comfortably and easily operate one or more user inputs (e.g., switches, buttons) disposed on a front or top of the housing of the cat wand while holding the housing. For example, the housing may be configured such that a user can use a finger (e.g., a thumb) to operate the one or more user input devices while holding the housing.

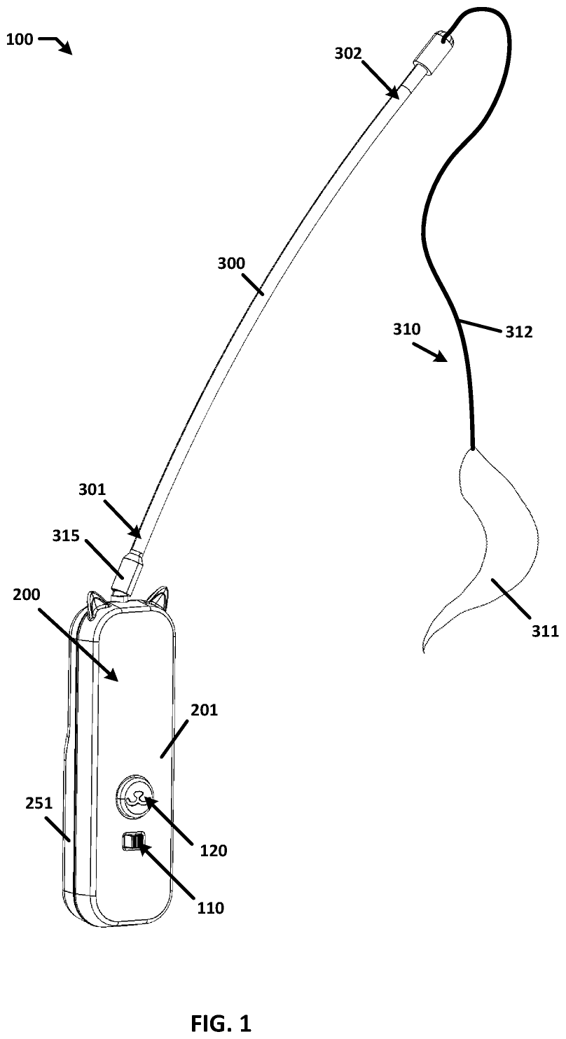

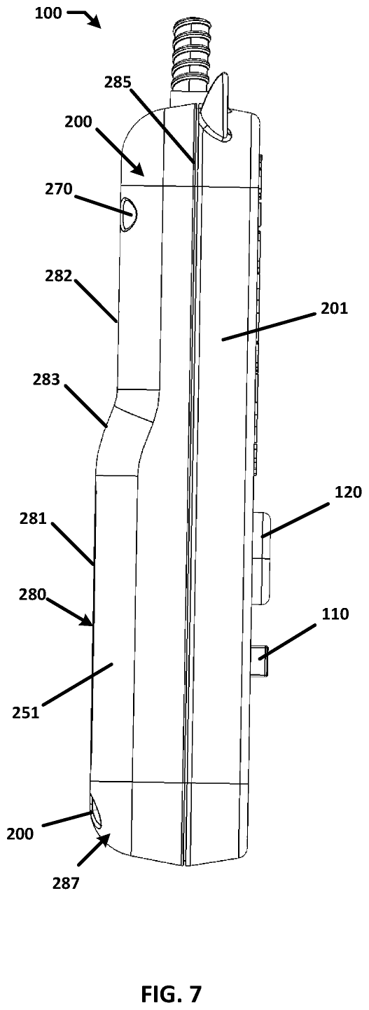

Referring to FIG. 1, a perspective view of a cat wand 100 (e.g., electronic cat wand, cat wand toy) is illustrated in accordance with one example of the present disclosure. As shown in FIG. 1, the cat wand 100 may include a handle or housing 200 and a wand 300 extending from the housing 200. According to some examples, the housing 200 may be configured be held by a user (e.g., human) playing with a pet. Specifically, the housing 200 may have an ergonomic shape that allows a user to operate one or more user input devices, for example, a switch 110 and/or button 120, while comfortably holding the housing 200. According to some examples, a switch 110 and/or a button 120 may be disposed at a front or top of the housing 200 and/or may be configured to be operated or actuated by a thumb of a user holding the housing 200. An ergonomic shape of the housing 200 according to some examples of the present disclosure is described further below with reference to FIG. 7.

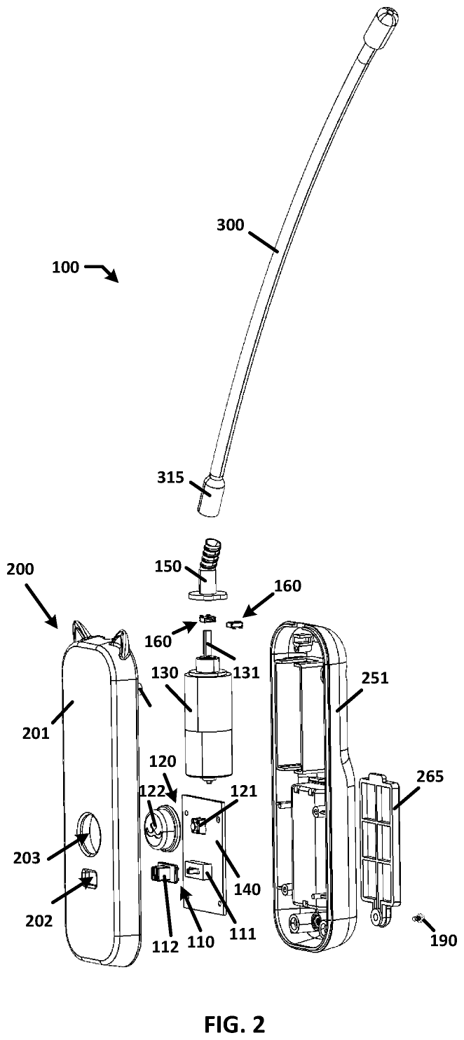

According to some examples, the housing 200 may include a front or first panel 201 and a back or second panel 251 coupled to one another. Referring generally to FIG. 2, one or more electronic components of the cat wand 100 may be disposed in the housing 200 (i.e., between the first panel 201 and the second panel 251). As illustrated in FIG. 2, a switch 110, a printed circuit board 140, and a motor 130 may be disposed in the housing 200. In some examples, one or more of a button 120, an attachment part 150, and a pair of limit switches 160 may also be disposed in the housing 200.

Referring to FIGS. 1 and 2, the cat wand 100 may include a wand 300 (e.g., elongate member) extending from the housing 200. The wand 300 may be coupled to the motor 130 included in the housing 200. The motor 130 may be configured to move the wand 300. Specifically, as shown in FIG. 2, the motor 130 may include a shaft 131 configured to rotate and/or vibrate. The shaft 131 and wand 300 may be coupled to one another such that when the shaft 131 rotates the wand 300 rotates and/or when the shaft 131 vibrates, the wand 300 vibrates.

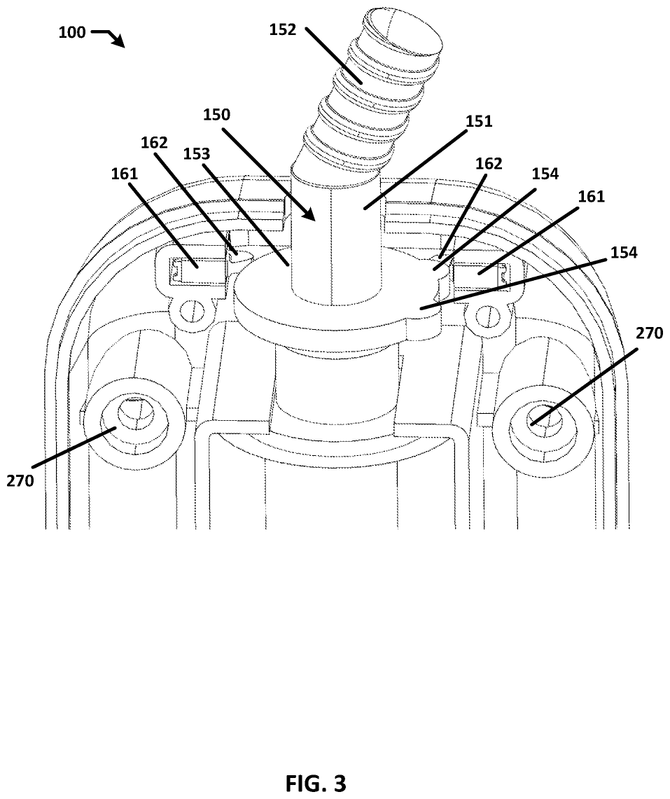

In some examples, the wand 300 and shaft 131 may be directly coupled. In other examples, as illustrated in FIGS. 1 and 2, an attachment part 150 (i.e., coupler) may be disposed between the motor 130 and the wand 300. According to some examples, as described below in greater detail with reference to FIG. 3, the attachment part 150 disposed between the shaft 131 of the motor 130 and the wand 300 may couple the shaft 131 and wand 300, such that the shaft 131 and wand 300 are askew or disposed at an angle relative to one another. Accordingly, in these examples, as the shaft 131 rotates, the attachment part 150 rotates, causing the wand 300 to rotate in a sweeping circular motion about a central axis of the shaft 131. A central axis of the wand 300 may be offset or spaced apart from the central axis of the shaft 131 along an entire length of the shaft 300 except the location where the wand 300 is coupled to the shaft 131. A distance between the central axis of the shaft 131 and the wand 300 may increase along the length of the wand 300 from a relatively small distance at the proximal end 301 to a relatively large distance at the distal end 302. Accordingly, the wand 300 may oscillate while being spaced apart from (e.g., disposed a distance away from) the central axis of the shaft 131.

Further, according to some examples, as described hereinafter in greater detail, the cat wand 100 may further include a pair of limit switches 160 configured to limit a range of motion of the shaft 131 and wand 300 as the shaft 131 and wand 300 rotate, such that the wand 300 oscillates (e.g., swings back and forth, moves back and forth in a sweeping motion) as the shaft 131 rotates (rather than rotating 360 degrees).

Still referring to FIG. 1, the wand 300 may include a proximal end 301 disposed adjacent to the housing 200 and a distal end 302 opposite the proximal end 301. In some examples, as illustrated in FIG. 1, the cat wand 100 may further include a wand accessory 310 coupled to the distal end 302 of the wand 300. The wand accessory 310 may be configured to elicit attention from and engage a pet as the wand 300 moves. The wand accessory 310 may include a lure or attractant 311 configured to attract a pet. The attractant 311 may be a feather, faux fur, a ball, a string, a bunch of feathers or strings, a plush toy, a plastic or otherwise chewable toy, or any combination thereof. In some examples, as illustrated in FIG. 1, the wand accessory 310 may include a string 312 coupled to the wand 300. Specifically, as illustrated in FIG. 1, one (e.g., first) end of the string 312 may be coupled to the distal end 302 of the wand 300 and the other (e.g., second) end of the string 312 may be coupled to an attractant 311, such that the attractant 311 hangs or dangles from the second end of the string 312. In other examples, the lure or attractant 311 may be directly coupled to the distal end 302 of the wand 300. The attractant may hang or dangle directly from the distal end 302 of the wand 300.

According to some examples, the wand 300 may be configured to bend (e.g., flex, deform) as it is moved. Specifically, the wand 300 may be composed of a flexible material configured to bend as the wand 300 moves. The wand 300 may be configured to bend due to its own weight and/or the weight of a lure or attractant 311 coupled to the wand 300. According to some examples, as described hereinafter in greater detail, the wand 300 may include a mounting cavity 315 configured to receive a portion of attachment part 150, for coupling the wand 300 to the attachment part 150.

Referring to FIG. 2, an exploded view of the cat wand 100 of FIG. 1 is illustrated in accordance with one example of the present disclosure. According to some examples of the present disclosure, as noted above, the cat wand 100 may include a switch 110, a printed circuit board 140, and a motor 130 disposed within the housing 200. In accordance with some examples of the present disclosure, the cat wand 100 may further include a button 120 and/or a pair of limit switches 160 disposed within the housing 200. Additionally, according to some examples, the cat wand 100 may include one or more fasteners 190 configured to couple or attach various constituent elements of the cat wand 100. According to the present disclosure, the fastener 190 may be any of a bolt, a screw, a rivet, a nail, or the like configured to couple two or more components of the cat wand 100.

According to some examples of the present disclosure, the printed circuit board 140 may be disposed within the housing 200 and include one or more control circuits configured to control operation of the cat wand 100. Specifically, in some examples, the control circuit may include a controller 180 and be configured to control movement of the wand 300 using one or more control signals. In other examples, the one or more control circuits may be configured to control movement of the wand 300, by controlling a supply of electric current to the motor 130. For example, a control circuit may control rotation and/or vibration of the wand 300 by selectively providing power to the motor 130 (i.e., such that the shaft 131 and wand 300 rotate and/or vibrate when current is supplied to the motor 130). In some examples, as described hereinafter in greater detail, the cat wand 100 may include a pair of limit switches 160, and the one or more control circuits may be configured to control a direction of movement (e.g., oscillation) of the wand 300 (i.e., by controlling a direction in which the shaft 131 rotates due to the limit switches 160).

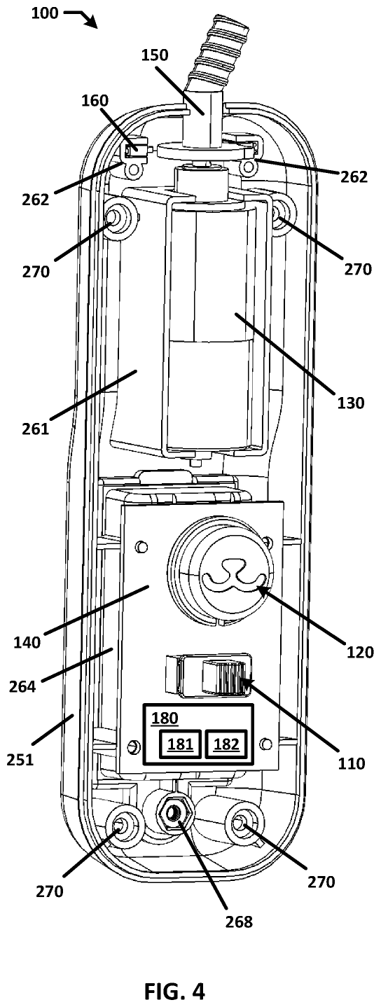

According to other examples of the present disclosure, the one or more control circuits may be implemented by a controller 180 including a processor 181 and memory 182. The memory 182 may store one or more sets of rules or algorithms for controlling the motor 130 (and thus the wand 300) and the processor 181 may implement or execute the one or more sets of rules or algorithms. Accordingly, the control circuit may include a controller 180 (e.g., processor 181 and memory 182) and may control the various operations of the cat wand 100 using one or more control signals (e.g., sent to the motor 130) based on an algorithm stored in the memory 182 and various user input signals and/or limit switch signals received by the processor 181. According to some examples, as illustrated in FIG. 4, the controller 180 may be included on the printed circuit board 140. In other examples, the controller 180 may be included as a part of the motor 130.

The processor 181 and the memory 182 may form a processing circuit. The processor 181 may execute instructions stored in the memory 182 or may access instructions otherwise accessible to the processor 181. The processor 181 may be embodied in various ways. The processor 181 may be constructed in a manner sufficient to perform at least the operations described herein. The processor 181 may be implemented as one or more general-purpose processors, application specific integrated circuits (ASICs), field programmable gate arrays (FPGAs), digital signal processors (DSPs), or other suitable electronic data processing components structed to execute instructions provided by memory. The processor 181 may take the form of a single core processor, multi-core processor (e.g., dual core processor, triple core processor, quad core processor, etc.) microprocessor, and the like.

The memory 182 may include non-transient volatile storage media, non-volatile storage media, non-transitory storage media (e.g., one or more volatile and/or non-volatile memories), etc. In some examples, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other examples, the volatile storage media may take the form of RAM, TRAM, ZRAM, etc. Combinations of the above are also included within the scope of machine-readable media.

The memory 182 may store machine-readable executable instructions which are executed by the processor 181. In this regard, machine-executable instructions comprise, for example, instructions and data which cause a general purpose computer, special purpose computer, or special purpose processing machines to perform a certain function or group of functions. The memory 181 may be operable to maintain or otherwise store information relating to the operations performed by one or more associated circuits, including processor instructions and related data (e.g., database components, object code components, script components, etc.), in accordance with the examples described herein.

The processor 181 may receive one or more user input signals (e.g., from the switch 110, button 120) and send one or more control signals to the motor 130, controlling the motor 130 based on the received user input signals and an algorithm for controlling the motor 130 stored in the memory 182. For example, the processor 181 may send one or more control signals to the motor 130 causing the motor 130 to do one or more of the following: begin rotating, causing the wand 300 to begin rotating or moving in a circle around a center axis of the shaft 131; stop rotating, causing the wand 300 to stop rotating or moving around a center axis of the shaft 131; begin vibrating, causing the wand 300 to begin vibrating; and stop vibrating, causing the wand 300 to stop vibrating.

Still referring to FIG. 2, the switch 110 may include a switch body 111 and a switch cover 112. The switch body 111 is electrically coupled to the printed circuit board 140 and may be configured to selectively open and/or close an electrical circuit. In some examples, the switch body 111 may be disposed on the printed circuit board 140. The switch 110 may further include a switch cover 112 configured to be placed on or over the switch body 111 and extend through a switch opening 202 formed in the first panel 201 of the housing 200. The switch cover 112 may extend through the switch opening 202 such that a user may toggle (e.g., actuate, operate) the switch 110 from outside the housing 200. Specifically, the switch 110 may be configured to selectively open and/or close a control circuit (e.g., included in the printed circuit board 140) and/or send one or more user input signals to a processor 181. The processor 181 may than send one or more control signals to the motor 130 based on the received user input signals and an algorithm stored in the memory 182 for controlling rotation of the shaft 131 of the motor 130, and thus, rotation of the wand 300.

According to some examples, the switch 110 may be toggleable between a first (e.g., off) position in which the motor 130 is controlled (e.g., by one or more control signals from the processor 181) so as to not rotate and/or in which current is not supplied to the motor 130 and a second (e.g., on) position in which the motor is controlled (e.g., by one or more control signals) to rotate and/or in which current is supplied to the motor, causing the shaft 131 of the motor 130 to rotate, and thus, causing the wand 300 coupled to the shaft 131 to rotate. According to some examples, when the switch 110 is in the second or on position, the controller 180 may vary a speed at which the shaft 131 of the motor 130 rotates (and thus the speed at which the wand 300 rotates), randomly change a direction of rotation of the shaft 131 of the motor 130 (and thus a direction in which the wand 300 rotates), and/or randomly stop the shaft 131 of the motor 130 from rotating for a varying period of time (and thus stop rotation of the wand 300 for a varying period of time). Specifically, the processor 181 may send one or more control signals to the motor 130, causing the motor 131 to change a speed at which the shaft 131 rotates, change a direction in which the shaft 131 rotates, stop rotation of the shaft 131, and/or resume or start rotation of the shaft 131 (after rotation has been stopped) based on an algorithm for controlling the motor 130 stored in the memory 182.

According to some examples, the cat wand 100 may further include a button 120. The button 120 may include a button body 121 and a button cover 122. The button body 121 is electrically coupled to the printed circuit board 140 and may be configured to selectively open and/or close an electrical circuit and/or send one or more signals to a processor. In some examples, the button 120 may be disposed on the printed circuit board 140. The button 120 may further include a button cover 122 configured to be placed on or over the button body 121 and extend through a button opening 203 formed in the first panel 201 of the housing 200. The button cover 122 may extend through the button opening 203 such that a user may press (e.g., actuate, operate) the button 120 from outside the housing 200. Specifically, the button 120 may be configured to selectively open and/or close a control circuit (e.g., included in the printed circuit board 140) and/or send one or more user input signals to the processor 181. The processor 181 may then send one or more control signals to the motor 130 based on the received user input signals and an algorithm stored in the memory 182 for controlling rotating and/or vibration of the shaft 131 included in the motor 130, and thus, rotation and/or vibration of the wand 300 coupled to the shaft 131.

According to some examples, when the button 120 is pressed (e.g., in a depressed state), the motor 130 may be controlled such that the shaft 131 included in the motor 130 does not rotate or stops rotating, and thus the wand 300 does not rotate or stops rotating. For example, when the button 120 is depressed, the button may send one or more user input signals to the processor 181 (e.g., for causing the motor 130 to stop rotating) and/or one or more control circuits included on the printed circuit board 140 may be open, such that current is not provided to the motor 130. The processor 181 may be configured to send one or more control signals in response to and based on the received user input signal(s) and an algorithm stored in the memory 182, controlling the motor 130 to not rotate or stop rotating. In accordance with some examples, in addition to stopping rotation of the wand 300, the button 120 may be configured to cause the wand 300 to vibrate when it is pressed (e.g., in a depressed state). Specifically, in some examples, when the button 120 is pressed (e.g., in a depressed state), the button 120 may send one or more user input signals to the processor 181. The processor 181 may then send one or more control signals to the motor 130 based on the received user input signals and an algorithm stored in the memory 182, causing the shaft 131 included in the motor 130 to vibrate, thus causing the wand 300 to vibrate.

In other examples, when the button 120 is depressed, the motor 130 may be controlled to cause the wand 300 to rotate while rapidly changing a direction in which the wand 300 rotates. Specifically, the processor 181 may send one or more control signals to the motor 130, based on an algorithm stored in the memory 182 causing the shaft 131 of the motor 130 to rotate at an increased speed and/or frequently change a direction of rotation of the shaft 131, thus increasing a speed at which the wand 300 rotates or oscillates and frequently changing a direction of motion of the wand 300, when the button 120 is depressed. Accordingly, in some examples, when the button 120 is depressed, the controller 180 may control the motor such that the wand 300 rapidly oscillates or shakes back and forth in a sweeping motion.

In another example, current may be selectively provided to the motor 130 for controlling vibration of the shaft 131, and thus, the wand 300. According to some examples, an algorithm stored in the memory 182 may dictate that the processor 181 only sends one or more control signals to the motor 130, causing the shaft 131 of the motor 130, and thus the wand 300 coupled to the shaft 131, to vibrate when the switch 110 is in the on or second position.

While a button 120 has been described herein, other types of actuators may be used to control the interrupting of the rotation of the wand 300 and the vibration of the wand 300. For example, another type of switch may be used in lieu of the button 120, where flipping the switch has the same effect as depressing the button 120. In another example, a trigger may be used in lieu of the button 120, where pulling the trigger has the same effect as depressing the button 120. These alternative actuators may be disposed on the housing 200 in such a way to allow a user to control them, and the switch 110 described above, in a simple manner with a single hand. For example, another switch (in lieu of the button 120) may be disposed in the same area as the button 120. A trigger may also be disposed in the same area as the button 120. A trigger may also be disposed on the opposite side of the housing as the switch 110, such that the switch 110 may be operated by a user's thumb while the trigger is operated by the user's index finger. Other actuators and configurations are possible.

Referring to FIG. 3, a partial perspective view of the cat wand 100 of FIG. 1 is illustrated in accordance with one example of the present disclosure. Referring generally to FIGS. 2 and 3, in accordance with some examples of the present disclosure, the cat wand 100 may further include an attachment part 150. The attachment part 150 may be disposed between the motor 130, specifically, the shaft 131 of the motor 130 and the wand 300.

According to some examples, the attachment part 150 may include a bend such that the wand 300 and shaft 131 are coupled while being disposed at an angle relative to one another. In some examples, as illustrated in FIGS. 2 and 3, the attachment part 150 may include a body 151 configured to receive the shaft 131 of the motor 130 and a threaded portion 152 extending from the body 151 and disposed at an angle with respect to the body 151. In this example, a central or longitudinal axis of the body 151 and a central or longitudinal axis of the threaded portion 152 are angled with respect to each other. As stated above, as the shaft 131 rotates, the attachment part 150 rotates, causing the wand 300 to rotate in a sweeping circular motion about a central axis of the shaft 131. Thus, the greater degree of angle between the body 151 and the threaded portion 152 results in a larger circle or arc that the wand 300 rotates about (i.e., the greater the bend of the threaded portion 152 increases the amplitude or size of the arc of rotation). As the size or amplitude of the arc of rotation increases, so too does the distance between the distal end 302 of the wand 300 and the central or longitudinal axis of the shaft 131. The threaded portion 152 may be configured to be inserted into the mounting cavity 315 included at the proximal end 301 of the wand 300. Specifically, the threaded portion 152 and the mounting cavity 315 may include mating threads, such that the mounting cavity 315 of the wand 300 may be twisted or screwed on to the threaded portion 152 of the attachment part 150, coupling the attachment part 150 and wand 300. The attachment part 150 may be disposed in the housing 200 and extend through an attachment part hole extending through and collectively formed by the first panel 201 and the second panel 251. According to some examples, the mounting cavity 315 and threaded portion 152 may be coupled to one another outside of the housing 200. According to some examples, the wand 300 and attachment part 150 may be coupled to one another in other ways. For example, one of the wand 300 and the attachment part 150 may include a male coupling feature and the other of the wand 300 and the attachment part 150 may include a female coupling feature, such that the wand 300 and attachment part 300 may fittedly snap together, coupling the wand 300 and attachment part 150. In other examples, one or more fasteners, such as screws, may be used to couple the wand 300 and the attachment part 150. Other types of fasteners may be used as well.

According to some examples, as illustrated in FIG. 3, the attachment part 150 may further include a cam 153 extending from the body 151 of the attachment part 150. The cam 153 may extend from the body 151 so as to be perpendicular (e.g., substantially perpendicular) to an axial direction of the body 151 and/or an axial direction of the shaft 131 coupled to and disposed within the body 151. According to some examples, as illustrated in FIG. 3, the cam 153 may have a circular or disk shape and extend from the body 151 around a perimeter of the body 151, such that the body 151 is disposed, and coupled to the cam 153, in the center of the cam 153. In some examples, one or more protrusions 154 may extend radially outward from a circumference of the cam 153. The one or more protrusions 154 may be configured to interact with (e.g., engage, abut, contact) a pair of limit switches 160 included in the cat wand 100 for controlling a range of rotation of the shaft 131 and thus the wand 300.

Referring to FIGS. 2 and 3, the cat wand 100 may further include a pair of limit switches 160. Each of the pair of limit switches 160 may be electrically connected to the printed circuit board 140 and/or the controller 180. Each limit switch 160 may include a limit switch body 161 and an actuator 162 extending from the limit switch body 161. Each limit switch 160 may be configured to selectively open or close a circuit and/or send one or more limit switch signals to the processor 181 of the controller 180 when a respective actuator 162 is engaged (e.g., contacted, abutted) and moved or pressed into the limit switch body 161. According to the present disclosure, one of the pair of limit switches 160 may be disposed on each side of the attachment part 150. Accordingly, as the attachment part 150 and the cam 153 rotate, a protrusion 154 extending from a circumference of the cam 153 may engage or contact a respective actuator 162 of a respective limit switch 160 disposed on one side of the attachment part 150 to open or close a circuit and/or send one or more limit switch signals to the processor 181 of the controller 180.

According to some examples, the processor 181 may be configured to reverse or change a direction of rotation of the shaft 131 of the motor 130 (and thus the wand 300) in response to a limit switch signal received from one of the pair of limit switches 160. Specifically, the processor 181 may reverse a direction of rotation of the shaft 131 (and thus the wand 300 and cam 153) in response to a limit switch signal from one of the pair of limit switches 160 and based on an algorithm for controlling the motor (e.g., and thus the wand 300) stored in the memory 182.

Accordingly, in some examples, when the switch 110 is disposed in the second or on position, the shaft 131 of the motor 130 may rotate in a first direction. As the shaft 131 rotates in the first direction, the attachment part 150 and wand 300 coupled to the shaft 131 may also rotate in the first direction. As the attachment part 150 rotates in the first direction, so too does the cam 153 and a protrusion 154 extending from the circumference of the cam 153 may engage or contact the actuator 162 of one (e.g., a first one) of the pair of limit switches 160, moving the actuator 162 into the body 161 of the limit switch 160 causing a circuit to be opened or closed and/or a limit switch signal to be sent from the limit switch 160 to the processor 181. In response to opening or closing of the circuit and/or receiving the limit switch signal, the processor 181 may send a control signal to the motor 130 to switch or reverse a direction of rotation of the shaft 131, causing the shaft 131, and thus, the attachment part 150, wand 300, and cam 153, to rotate in a second, opposite direction. As the attachment part 150 rotates in the second direction a protrusion 154 extending from the circumference of the cam 153 may engage or contact the actuator 162 of the other (e.g., second one) of the pair of limit switches 160, moving the actuator 162 into the body 161 of the limit switch 160 causing the limit switch 160 to send a limit switch signal to the processor 181. In response to receiving the limit switch signal, the processor 181 may send a control signal to the motor 130, causing the motor 130 to switch or reverse the direction of rotation of the shaft 131, causing the shaft 131, and thus, the attachment part 150, wand 300, and cam 153, to rotate in the first direction.

Accordingly, a direction of rotation of the shaft 131, attachment part 150, cam 153, and wand 300 may be alternated or reversed each time a protrusion 154 extending from a circumference of the cam 153 contacts or abuts an actuator 162 of one of the pair of limit switches 160. Specifically, the attachment part 150, pair of limit switches 160, and processor 181 may be configured to limit a range of motion or rotation of the shaft 131, the attachment part 150, and the wand 300 and repeatedly alternate a direction of rotation of the shaft 131, attachment part 150, and wand 300, causing the wand 300 to oscillate back and forth in a sweeping motion along the limited range of motion or rotation of the wand 300.

The attachment part 150 may include one or more protrusions 154 extending from the circumference of the cam 153. According to some examples, a length (e.g., radially along the circumference of the cam 153) of the one or more protrusions 154, a distance between two or more protrusions 154, and a position of each of the pair of limit switches 160 may determine a range of motion (e.g., rotation) of the attachment part 150 and the shaft 131, and thus a range of motion (e.g., oscillation) of the wand 300.

According to some examples of the present disclosure, as the wand 300 oscillates back and forth in a sweeping motion the controller 180 may, as described above, vary a speed at which the shaft 131 of the motor 130 rotates (and thus the speed at which the wand 300 rotates), randomly change a direction of rotation of the shaft 131 of the motor 130 (and thus a direction in which the wand 300 rotates), and/or randomly stop the shaft 131 of the motor 130 from rotating for a varying period of time (and thus stop rotation of the wand 300 for a varying period of time).

In accordance with other examples of the present disclosure, a cam (e.g., cam wheel) may be configured to rotate about an axis perpendicular to a direction of motion of the wand 300. In these examples, a cam pin extending from a surface of the cam may be disposed in a slotted lever or cam arm coupled to (e.g., the proximal end 301) of the wand 300. Accordingly, as the cam rotates the cam pin may move within the slot or opening formed in the cam arm, moving the cam arm as the pin contacts a wall or surface of the slot or opening. The shape of the cam arm, the shape of a slot or opening included in the cam arm, and/or the location of a pivot point (e.g., at which the cam arm is coupled to the (e.g., proximal 301) end of the wand 300 may all be varied to vary a range of motion of the wand 300. Referring to FIG. 4 a partial perspective view of the cat wand 100 of FIG. 1 is illustrated in accordance with one example of the present disclosure. According to some examples, the second panel 251 may further include a motor compartment 261 configured to receive and hold the motor 130. The motor compartment 261 may include one or more (e.g., five) walls configured to abut and maintain a position of the motor 130 within the housing 200. According to some examples, the second panel 251 may further include a pair of limit switch brackets 262. Each of the pair of limit switch brackets 262 may be configured to receive and maintain a position of one of the pair of limit switches 160 within the housing 200. In some examples, each of the limit switch brackets 262 may include four surfaces configured to abut and maintain a position of a respective limit switch 160 of the pair of limit switches 160.

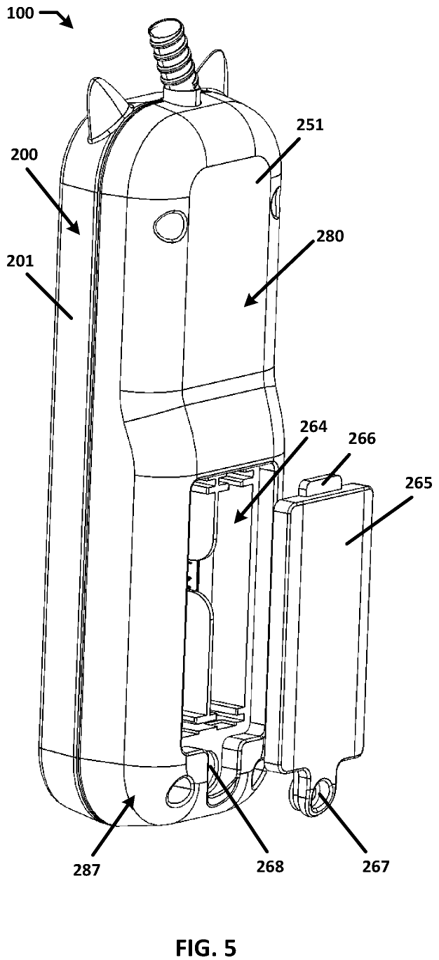

Referring to FIG. 5, a partial perspective view of a back of the cat wand 100 of FIG. 1 is illustrated in accordance with one example of the present disclosure. Referring to FIGS. 4 and 5, according to some examples, the second panel 251 may include a battery compartment 264 configured to receive and/or store one or more batteries for providing power to the circuit board 140 (i.e., control circuit(s), controller 180) and/or motor 130. According to some examples, the battery compartment 264 may include one or more terminals electrically connected to the printed circuit board 140 and/or motor 130. In some examples, the battery compartment 264 may be configured to receive and store one or more disposable batteries configured to power the cat wand 100 (e.g., controller 180, motor 130). In other examples, the battery compartment 264 may be configured to receive and store one or more rechargeable batteries configured to power the cat wand 100 (e.g., controller 180, motor 130). In some examples, the second panel 251 may include a charging port allowing the one or more rechargeable batteries to be recharged (e.g., via a charger or power cord connected to a wall outlet).

Additionally, the second panel 251 may include a battery cover 265 removably coupled to the second panel 251 and configured to selectively close or cover the battery compartment 264. In some examples, the battery cover 265 may include a tab 266 configured to be inserted into a corresponding notch in the second panel 251 and a cover coupling hole 267 configured to receive a fastener 190 for coupling the battery cover 265 to the second panel 251. Specifically, the second panel 251 may include a battery cover mounting hole 268 configured to receive a fastener 190 extending through the cover coupling hole 267 for coupling the battery cover 265 to the second panel 251.

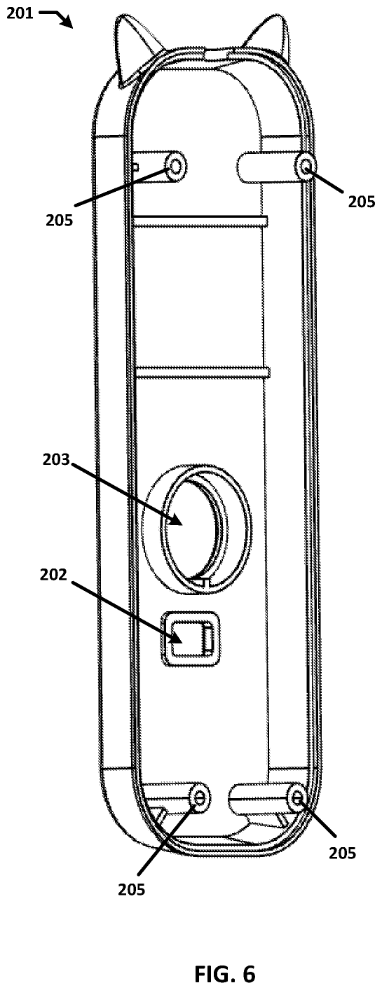

Referring to FIG. 6, a perspective view of a back of the first panel 201 of the cat wand 100 of FIG. 1 is illustrated in accordance with one example of the present disclosure. Referring to FIGS. 4 and 6, according to some examples, the first panel 201 may include one or more columns 205 and the second panel 251 may include one or more receptacles 270 configured to receive a respective one of the columns 205 included in the first panel 201. According to the present disclosure, each of the columns 205 included in the first panel 201 may be inserted into a corresponding receptacle 270 included in the second panel 251, coupling the first panel 201 and the second panel 251. In accordance with some examples, after each the column 205 has been inserted into a corresponding receptacle 270, a fastener 190 may be inserted (e.g., from a back side of the second panel 251) through the receptacle 270 and into a cavity included in the column 205 configured to receive the fastener 190. The fastener 190 may be a bolt, screw, rivet, or the like. In some examples, the fastener 190 may threadedly engage the inner surface of the cavity included in the column 205.

Referring to FIG. 7, a partial side view of the cat wand of FIG. 1 is illustrated in accordance with one example of the present disclosure. As noted above, according to some examples of the present disclosure, the housing 200 may have an ergonomic shape allowing the housing 200 to be comfortably held by a user and allowing a user to hold and operate one or more user input devices, for example, switch 110 or button 120, with a single hand. According to some examples, the second panel 251 may include a contoured back surface 280 configured to fit comfortably into a user's hand. Specifically, in some examples, the back surface 280 may include a first portion 281 offset or disposed a first distance from a front edge 285 of the second panel 251 and a second portion 282 offset or disposed a second distance, less than the first distance, from the front edge 285 of the second panel 251. Accordingly, as illustrated in FIG. 7, a width or thickness of the second panel 251 and thus the housing 200 may vary along a length of the second panel 251 and/or housing 200, respectively. In addition to being more ergonomic, the increased width or thickness of the second panel 251 allows the housing 200 to accommodate more components, such as the motor 130 and batteries.

According to some examples, the back surface 280 of the second panel 251 may further include a neck or converging portion 283 extending between the first portion 281 and the second portion 282 of the back surface 280. In other words, the width or thickness of the second panel 251 necks down from the first portion 281 to the second portion 282 at the converging portion 283. Additionally, referring to FIGS. 5 and 7, in some examples, one or more edges 287 of the back surface 280 may be rounded, such that a user may comfortably grasp the back surface 280 of the second panel 251.

While the present disclosure has been described with reference to specific examples, which are intended to be illustrative only and not to be limiting of the disclosure, it should be apparent to those of ordinary skill in the art that changes, additions and/or deletions may be made to the disclosed embodiments without departing from the spirit and scope of the disclosure.

The foregoing description is given for clarity of understanding only, and no unnecessary limitations should be understood therefrom, as modifications within the scope of the disclosure may be apparent to those having ordinary skill in the art.

When a component, device, element, or the like of the present disclosure is described as having a purpose or performing an operation, function, or the like, the component, device, or element, should be considered herein as being “configured to” meet that purpose or perform that operation or function.

What is claimed is:

1. An electronic pet wand comprising:
a housing;
a wand extending from the housing; and
a motor disposed in the housing configured to oscillate the wand.

2. The electronic pet wand of claim 1, further comprising:
a control circuit including a switch movable between a first position and a second position, the control circuit configured to cause the motor to oscillate the wand when the switch is in the second position.

3. The electronic pet wand of claim 2, further comprising:
a button,
wherein the control circuit is configured to stop the motor from oscillating the wand when the button is depressed.

4. The electronic pet wand of claim 3, wherein the control circuit is configured to cause the motor to vibrate the wand when the button is depressed.

5. The electronic pet wand of claim 1, wherein the housing includes a first panel and a second panel.

6. The electronic pet wand of claim 5, wherein the housing is configured to be held by a user.

7. The electronic pet wand of claim 6, wherein a first portion of a back surface of the second panel is disposed a first distance from a front edge of the second panel, and a second portion of the back surface of the second panel is disposed a second distance, less than the first distance, from the front edge of the second panel.

8. The electronic pet wand of claim 7, wherein the back surface of the second panel includes a converging portion extending between the first portion of the back surface and the second portion of the back surface.

9. The electronic pet wand of claim 5, wherein the second panel includes a battery compartment and a battery cover removably coupled to the second panel.

10. The electronic pet wand of claim 1, further comprising:
an accessory coupled to a distal end of the wand.

11. The electronic pet wand of claim 2, further comprising:
a motor attachment disposed between the motor and the wand; and
a pair of limit switches, one of the pair of limit switches being disposed on each side of the motor attachment,
wherein the control circuit is configured to reverse a direction in which the motor moves the wand each time the motor attachment contacts one of the pair of limit switches.

12. An electronic cat wand comprising:
a housing configured to be held by a user;
a wand extending from the housing; and
a motor disposed in the housing configured to oscillate the wand.

13. The electronic cat wand of claim 12, wherein the housing includes a first panel and a second panel.

14. The electronic cat wand of claim 13, wherein a first portion of a back surface of the second panel is disposed a first distance from a front edge of the second panel, and a second portion of the back surface of the second panel is disposed a second distance, less than the first distance, from the front edge of the second panel.

15. The electronic cat wand of claim 14, wherein the back surface of the second panel includes a converging portion extending between the first portion of the back surface and the second portion of the back surface.

16. The electronic cat wand of claim 12, further comprising:
an accessory coupled to a distal end of the wand.

17. An electronic cat wand comprising:
a handle;
a wand extending from the handle; and
a motor disposed in the handle configured to oscillate the wand.

18. The electronic cat wand of claim 17, further comprising:
a control circuit disposed in the handle and including a switch movable between a first position and a second position, the control circuit configured to cause the motor to oscillate the wand when the switch is in the second position.

19. The electronic cat wand of claim 18, further comprising:
a button,
wherein the control circuit is configured to stop the motor from oscillating the wand when the button is depressed.

20. The electronic cat wand of claim 18, wherein the handle includes a first panel and a second panel.
